(19) United States
(12) Patent Application Publication
(10) Pub. No.: US 2026/0093664 A1
(43) Pub. Date: Apr. 2, 2026

(54) RESOURCE OPTIMIZER FOR CUSTOMER DATA PLATFORM

(71) Applicant: Oracle International Corporation, Redwood City, CA (US)

(72) Inventors: Rajkumar Srinivasan, Bengaluru (IN); Pradeep Grandhi, Bengaluru (IN); Vishal Bhat, Bengaluru (IN); Madalasa Venkataraman, Bengaluru (IN); Tribhuwan Singh, Bengaluru (IN)

(21) Appl. No.: 18/901,264

(22) Filed: Sep. 30, 2024

(51) Int. Cl. G06F 16/11; G06F 11/14; G06F 12/02; G06F 16/16

(52) U.S. Cl. CPC G06F 16/113; G06F 11/1469; G06F 12/0276; G06F 16/164

(57) ABSTRACT

Various embodiments of the present technology generally relate to systems and methods for optimizing resources within a customer data platform (CDP). In certain embodiments, a method may comprise operating a resource optimizer system to implement a CDP resource optimization process to remove obsolete metadata, the CDP resource optimization process including monitoring metadata usage within a CDP, generating metrics for a metadata element based on the metadata usage, defining a rule set for selecting the obsolete metadata for removal based on the metrics, and applying the rule set to remove the obsolete metadata.

### TECHNICAL FIELD

Various embodiments of the present technology generally relate to the improvement in functionality for a customer data platform (CDP). More specifically, embodiments of the present technology relate to systems and methods for optimizing resources and cleaning up metadata within a CDP.

### BACKGROUND

In today's data-driven landscape, customer data platforms (CDPs) are at the forefront of capturing, managing and analyzing a diverse and ever-expanding array of customer information. A CDP may be a software-based product that can combine data from multiple sources and tools in order to create a centralized customer database having data on all touch points and interactions with a company's product or service. The database can be segmented in highly customizable ways to create personalized marketing campaigns. Data segmentation may refer to the process of organizing company data into groups based on shared characteristics. For example, customer data can be segmented by location, age, interests, or preferred touch points or platforms. Campaigns may be targeted advertising to reach a customer across various different channels (e.g., via different types of advertising or contact points). Businesses increasingly rely on CDPs to consolidate, manage and analyze vast amounts of customer data to drive personalized marketing strategies and deliver hyper-personalized customer experiences.

From traditional demographic details to intricate behavioral and transactional data, the complexity and volume of data consumed daily requires a robust CDP infrastructure capable of handling various applications and functionality. For example, multiple integrations to allow facilitating data exchange across varied sources and destinations, efficient ingestion for streamlining the capture of data from diverse sources, dynamic data management for supporting both raw and processed data through adaptive objects and attributes, advanced segmentation to enable intent-curated segments for marketers to effectively target prospects and customers, and effective export and campaign management for ensuring seamless data delivery for targeted marketing efforts.

This escalating data complexity inevitably leads to the accumulation of extensive metadata, which can impact resource allocation and system performance. As CDPs scale to accommodate growing volumes of data & metadata, they encounter significant challenges that can impede their efficiency and effectiveness. Over time, the accumulation of rarely used or obsolete system entities ranging from jobs to data objects to integrations and queries becomes unavoidable. This not only leads to resource contention, reducing the overall performance and responsiveness of the CDP, but it also complicates the user interface (UI) and further user experience of the CDP, making it difficult for marketers and data analysts to navigate and extract value from customer data.

The problem is multifaceted and impacts businesses at various levels. Operational efficiency is reduced when the clutter of unnecessary metadata and system entities slows down system operations, leading to longer processing times and reduced agility in responding to market changes. Cost implications arise when resource contention necessitates additional computing and storage resources, escalating operational costs. User experience is degraded, since a cluttered and complex user interface hampers productivity, making it challenging for users to efficiently manage campaigns or derive insights. Further, outdated metadata and system entities not only occupy valuable space but also detract from the platform's operational relevance, leading to inefficiencies in data management and utilization.

To address these challenges, a strategic focus on metadata analysis is imperative for optimizing resource utilization. Accordingly, there exists a need for improved systems and methods for optimizing resources within a CDP.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for implementing an application optimization framework. In an embodiment, a resource optimizer system may comprise one or more processors, and a memory having stored thereon instructions that, upon execution by the one or more processors, cause the one or more processors to implement a customer data platform (CDP) resource optimization process to remove obsolete metadata. The resource optimizer system may monitor metadata usage within a CDP, generate metrics for a metadata element based on the metadata usage, define a rule set for selecting the obsolete metadata for removal based on the metrics, and apply the rule set to remove the obsolete metadata.

In some embodiments of the resource optimizer system, removing the obsolete metadata includes archiving the obsolete metadata. The resource optimizer system may generate a rule for the rule set based on the metrics, receive a user customization to the rule to produce a customized rule, and apply the rule set, including the customized rule, to remove the obsolete metadata. In some examples, to apply the rule set the resource optimizer system may tag selected metadata as ready for removal, receive a user input to mark chosen metadata from the selected metadata for removal, and remove only the chosen metadata from the selected metadata. The resource optimizer may tag first metadata for user-approved removal, and automatically remove second metadata without user approval. According to certain embodiments, the resource optimizer system may determine dependencies between CDP metadata within the CDP, and generate a visualization depicting the dependencies on a user interface (UI). In some examples, the resource optimizer system may provide a rollback option enabling a user to restore archived metadata, receive a selection of rollback metadata via the rollback option, and restore the rollback metadata to the CDP. The resource optimizer system may generate a notification identifying the obsolete metadata removed by the CDP resource optimization process, and a corresponding rule based on which each obsolete metadata element was removed, and provide the notification to the user. In some examples, the resource optimizer system may generate suggestions of metadata to consider for removal based on the metrics, the suggestions not based on the rule set, and provide the suggestions to the user. In some embodiments, the metrics identify an amount of time since the metadata element has been utilized.

In an alternative embodiment, a method may comprise operating a resource optimizer system to implement a CDP resource optimization process to remove obsolete metadata, the CDP resource optimization process including monitoring metadata usage within a CDP, generating metrics for a metadata element based on the metadata usage, defining a rule set for selecting the obsolete metadata for removal based on the metrics, and applying the rule set to remove the obsolete metadata.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of an example system configured to implement a resource optimizer for a customer data platform, in accordance with certain embodiments of the present disclosure;

FIG. 2 is a diagram of an example system configured to implement a resource optimizer for a customer data platform, in accordance with certain embodiments of the present disclosure;

FIG. 3 is a flow diagram of an example system for implementing a resource optimizer for a customer data platform, in accordance with certain embodiments of the present disclosure;

FIG. 4 is a flowchart of a method for implementing a resource optimizer for a customer data platform, in accordance with certain embodiments of the present disclosure; and

FIG. 5 is a diagram of a system configured to implement a resource optimizer for a customer data platform, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

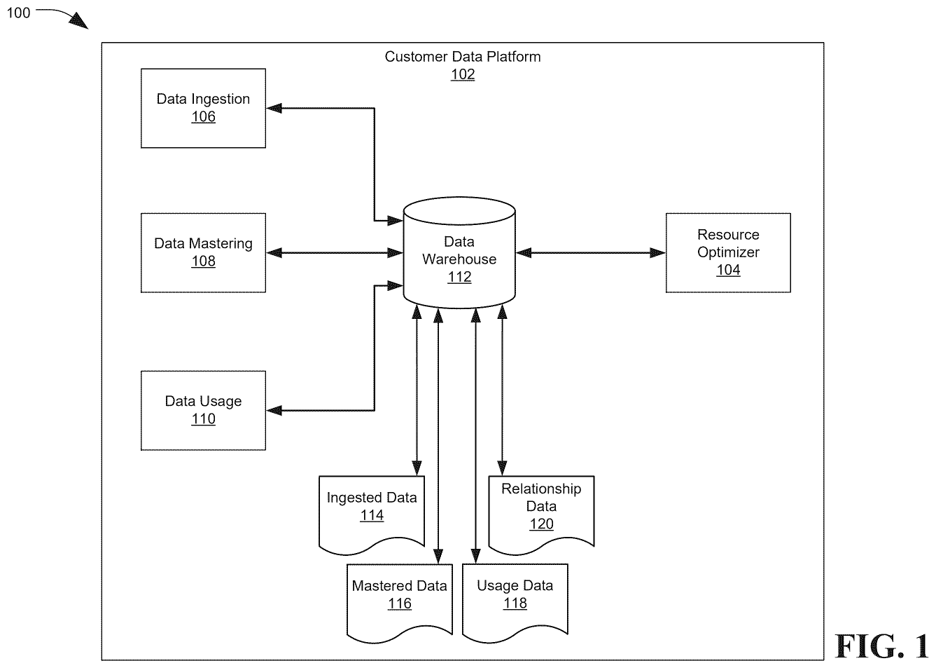

FIG. 1 is a diagram of a system 100 configured to implement a resource optimizer for a customer data platform, in accordance with certain embodiments of the present disclosure. The example system 100 may include a customer data platform (CDP) 102, which may be provided to clients or customers via a software as a service (Saas) or platform as a service (PaaS) model deployed in a cloud environment. The CDP 102 may include a data ingestion module 106, a data monitoring module 108, a data usage module 110, and a data warehouse 112. Further, system 100 may include a resource optimizer module 104, which may be part of CDP 102 or external to it. For example, a CDP provider may include the resource optimizer 104 functionality into its CDP product, or a resource optimizer 104 service or functionality may be provided to a CDP provider by a third-party vendor or as an external tool or software modification.

A CDP, such as Oracle Unity or Oracle Fusion CDP, may be a massive data aggregator and processor. It can gather disparate data from internal and external sources; perform advanced analysis; augment, clean, and standardize the data; and then rewrite it into logical tables so that it can be consumed by jobs, segments, campaigns, etc. All these processes may be predominantly based on metadata tagging and management.

The data ingestion module 106 may be configured to perform data collection for customer behavioral & transaction data, first party data, mobile and device data, personal and demographic data, or other customer data. The data ingestion module 106 may collect data from different tools to consolidate in one place. Tools may include data sources from which the CDP may obtain data, such as a company's website, Facebook®, applications, customer support live chat, help desk interactions, email, etc. Each time a customer visits a company's website, views or interacts with ads on third-party websites, uses the company's app, contacts the company via telephone or live chat, or otherwise creates touchpoints, data and metadata on the interaction or customer demographics may be collected by the CDP 102 via the data ingestion module, thereby resulting in ingested data 114 stored to the data warehouse 112.

The data mastering module 108 may be configured to perform processing to clean up the ingested data 114 to create actionable mastered data 116. The data mastering module 108 may perform data governance to validate, enforce, extra, and transform the ingested data 114. For example, this may include checking the data for errors, making sure the data follows any imposed protocols and conforms with personally identifiable information (PII) requirements or rules, or other checks. Data mastering module 108 may perform data synthesizing and deduplication to consolidate or eliminate duplicative data, such as to avoid having multiple entries for a same customer (e.g., Chris Holder, Chris T. Holder, Christopher Holder, and Christopher Thomas Holder may all be a same customer). Related and duplicative data may be merged into a unified profile. Processed data may be stored to data warehouse 112 as mastered data 116.

Data usage module 110 may be configured to utilize the mastered data 116, via the providing of customer profiles and data to other tools used to improve the customer experience. For example, tools may include email mailings, online advertising, customer relations management (CRM), mobile software development kits (SDKs), such as to utilize on a Facebook® ads platform. Data usage may encompass segmentation, campaign activations, role-based and organization-based access controls (e.g., different access rights to various data for different brands or companies under a single umbrella company), data science models, etc. Data science modeling may be the process of creating algorithms and statistical models to analyze and interpret complex data, and a data science model may organize data elements and standardize how the data elements relate to one another and to the properties of real-world entities. The data usage module 110 may allow users of the CDP 102 to create jobs, segmentations, campaigns, or other usages of the mastered data 116, which may be stored to the data warehouse 112 as usage data 118.

Relationship data 120 may also be stored to the data warehouse 112, either by data usage model 110, data mastering module 108, or another component. Relationship data may include information on how various data or metadata are related to each other, and what data elements depend on or interact with other data elements.

As noted, the CDP 102 may receive, store, and manage vast amounts of data, but it also stores and manages a huge quantity of metadata, which may be information about or related to underlying data. For example, a customer may have data elements such as a name, phone number, and email address, which may be stored to a table called “customer”. That customer table may have a lot of metadata associated with it, such as configuration of the table and details about the table. The metadata may include the name of the data table, the types of identifiers and column names for the ‘customer’ data object, the bucketing strategy, the partitioning strategy, and other information related to the customer data object and how it's stored. Related information may include segmentations for the data, data queries or search histories, what jobs (e.g., report generation jobs) are associated with the table, access rights for the data, and various other information. Together with the underlying data itself, this metadata can become a resource strain on the CDP, and an impediment to the user experience. Physical storage may be consumed, processing may slow down as metadata accumulates, and users may have to scroll or page through multiple screens of redundant or outdated jobs or queries to locate the ones they want, or instead create a new, potentially duplicative, job or query. Each process performed within the CDP 102 may rely upon, create, or utilize metadata.

In order to address these issues and maintain a high performance of the CDP 102, a resource optimizer 104 may be used with the CDP 102. The resource optimizer 104 may be configured to efficiently identify and remove redundant or obsolete system metadata and associated entities, and ensure that every aspect of the CDP 102, from data ingestion to processing to campaign activation, operates at peak efficiency. This targeted approach of resource optimization can result in a noticeably faster, more responsive system 100 that can handle increasing volumes of data and metadata without degradation in performance. Further, by eliminating unnecessary elements and streamlining navigation, the resource optimizer 104 may facilitate more simple, intuitive, and efficient user interaction with the CDP 102. This can lead to improved user satisfaction, enabling marketers and data scientists to focus on strategic tasks without navigating through irrelevant data or functionalities. The elimination of redundant or obsolete elements can provide cost reductions across data storage and infrastructure, and also decrease the computational resources needed for data processing. This holistic approach to cost optimization is especially advantageous over solutions that only address one aspect of cost reduction, offering a more sustainable & scalable model for CDP operations without escalating expenses. The resource optimizer 104 may be applicable to ecosystems of all Enterprise products that are heavily metadata dependent.

The resource optimizer 104 may apply rule-based algorithms to identify, alert, and manage obsolete or redundant entities. The resource optimizer 104 may provide a way for users to focus on active jobs, engagements, processes while at the same time optimizing the system 100 performance by archival of stale jobs and processes. To implement these improvements, the resource optimizer 104 may employ a variety of processes or operations.

The resource optimizer 104 may perform monitoring of the system 100 metadata utilization, and generate analytical reports on usage frequency of the various metadata elements. For example, metadata elements may have associated “last accessed” or “last updated” dates or times associated with them, indicators of how often the elements are accessed, or other associated details. The resource optimizer 104 may periodically check and compile these usage statistics into a report that indicates how often or how long ago each element was used.

Based on the usage information, the resource optimizer 104 may perform metrics generation, including building intelligence around the active metadata life cycle. For example, the resource optimizer may develop and share metrics that highlight, e.g., campaigns not used in the past 30 days, jobs not run in the past 60 days, etc.

The resource optimizer 104 may leverage a rules-based engine and define intelligent rules based on the generated metrics as a default mechanism for the cleanup process. For example, the resource optimizer may develop rules for automatically archiving various kinds of metadata according to intelligent rules, such as to archive campaigns not used for a first period of time (e.g., 90 days), or jobs not used for a second period of time (e.g., 60 days). These rules may be based on default settings (e.g., specified inactive periods based on a type of metadata element), or the rules may be based on the customer's usage patterns (e.g., by determining usage patterns associated with “active” usage for that customer). Apart from the automated intelligent rules generation, the resource optimizer 104 may allow the customization of rules used for tagging and archival of metadata from a user interface (UI). The rules for archiving may be applied automatically, or they may be applied after approval by a user or administrator, or some combination thereof.

In some embodiments, the resource optimizer 104 may employ “tagging” to identify metadata with “ready for archival” status, and display the same in a UI for users to visualize and take necessary actions accordingly. The UI may also allow for user-level metadata tagging, for enhanced analysis on configurations done at the user level and making one-step decisions for archival or tagging of all distributed changes made by a particular user. In an example embodiment, the resource optimizer 104 may be configured to automatically archive metadata that meets selected criteria, and “tag” other metadata for user review prior to archiving. The user may opt to archive or not archive tagged data, and may also select other, non-tagged elements for archival. For example, if an employee of the customer has left their position, an administrator may choose to archive all campaigns or jobs created by that employee.

The resource optimizer 104 may be configured to determine and highlight the dependencies of metadata elements using a graph database (DB) and the UI. The resource optimizer 104 may create a tree or directed acyclic graph (DAG) structure to visualize the dependencies between metadata elements. For example, an ingested data source may be used to populate a table, and the table may be used to run a segmentation or job, and so on. The graph or visualization may enable a customer to see how metadata elements relate, and to archive complete end to end chains of metadata or make necessary replacements to avoid downstream impacts due to archival of metadata. The dependency or relationship data may be stored to resource optimizer 104 or data warehouse 112 as relationship data 120.

The resource optimizer 104 may employ scheduling of automated jobs to trigger at a regular cadence and perform the cleanup activity based on the defined rules. For example, the resource optimizer 104 may scan metadata usage and generate reports at a selected interval, update the graph DB at a selected interval, perform automatic archival and tagging at a selected interval, and archive elements approved by a user at another interval.

The resource optimizer 104 may generate and send notifications for users or administrators, both at a job level and at an alert level. Job level notifications may be sent along with activity logs that identify the metadata archived along with the corresponding rule that resulted in the archival, once the cleanup activity is completed. Alert notifications may be sent based on the metrics generated from metadata monitoring, to highlight the potential areas that need attention for archival or to identify tagged metadata.

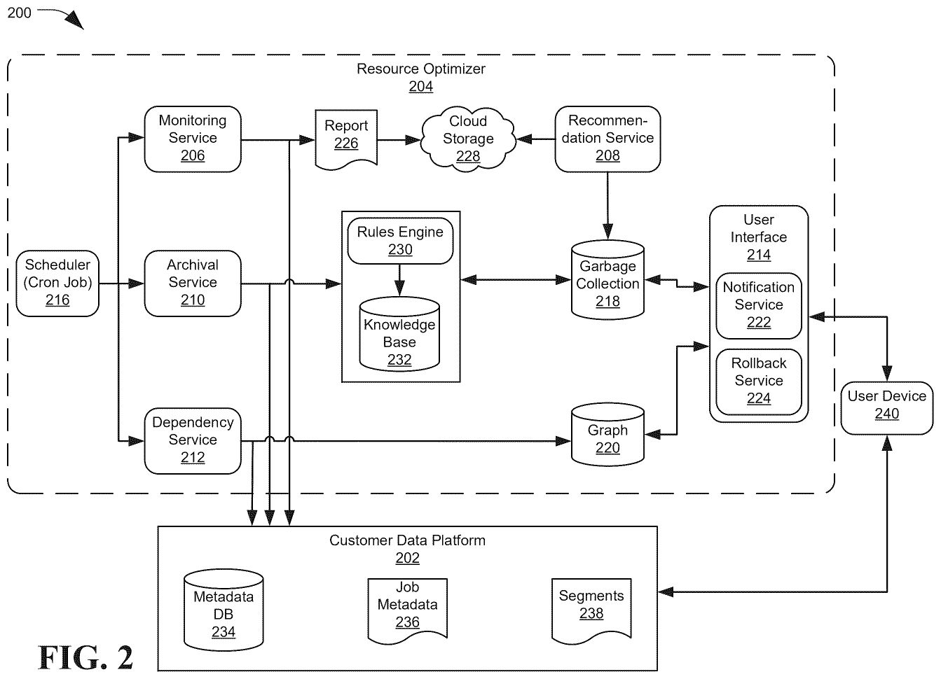

The resource optimizer 104 may also provide a rollback mechanism allowing for the retrieval or restoration of archived metadata. For example, some metadata may be automatically archived that a customer may later determine is still useful. In another example, a customer may select to archive data upon which other elements depended, without realizing it. By archiving old metadata instead of deleting it, the data may be moved to slower or less expensive physical storage, not undergo normal processing that may slow system performance, and removed from cluttering up the UI, but still be safe and available if a customer determines the data is desired. In other embodiments, some or all metadata may be marked for permanent deletion, either based on rules applied by the resource optimizer 104, or as selected by a user. A system for implementing a resource optimizer 104 is discussed in regard to FIG. 2.

FIG. 2 is a diagram of a system 200 configured to implement a resource optimizer for a customer data platform, in accordance with certain embodiments of the present disclosure. In particular, system 200 may depict an example set of elements of a resource optimizer 204, as well as a customer data platform (CDP) 202 and a user device 240. The CDP 202 and resource optimizer 204 may correspond to CDP 102 and resource optimizer 104 of FIG. 1, respectively.

CDP 202 may include a metadata database (DB) 234, a collection of job metadata 236, and a collection of segments 238. Job metadata 236 and segments 238 may be examples of metadata elements within the CDP 202, and may be stored in metadata DB 234, along with other metadata elements.

Resource optimizer 204 may include a monitoring service 206, a recommendation service 208, an archival service 210, a dependency service 212, a user interface (UI) 214, a scheduler 216, a garbage collection database 218, a graph database 220, and a knowledge base database 232.

Monitoring service 206 may scan the metadata DB 234 from CDP 202, and generate a report 226 on usage frequency of the metadata elements. The report 226 may identify a last time an element was used, how frequently the element is used, when an element was created, who the element was created by or for, or other details that may be useful in determining whether the metadata is still active or relevant. In some embodiments, the report 226 may be stored to a cloud storage service or element 228, or to another memory or database accessible by resource optimizer 204.

The recommendation service 208 may employ data science jobs to generate analytical metrics based on processing the usage report 226. The recommendation service 208 may receive the usage report 226 from monitoring service 206, or retrieve it from cloud storage 228. Data science jobs may use models to organize data elements and standardize how the data elements relate to one another and to properties of real-world entities. The evaluation of the report 226 by the recommendation service 208 may result in insights or suggestions for customers regarding their metadata. For example, the recommendation service may suggest a user evaluate certain metadata elements that may no longer be relevant (e.g., based on age since creation or use, or based on the element being created by a user that no longer has access rights), or even to highlight metadata that is highly active. The recommendations may include merely bringing metadata to a user's attention, or in some examples may include tagging metadata, or updating a rules engine 230 based on the evaluation of the report 226. The recommendations may be stored to the garbage collection DB 218.

Based on the metrics or recommendations generated by recommendation service 208, the rules engine 230 may be updated with default customizable rules for metadata archival. For example, the recommendation service 208 may identify certain types of metadata that rarely get used after a certain age or time since last access, and based on these metrics the rules engine 230 may be updated with rules to tag or archive relevant metadata past that age or last access period. The default rules at the rules engine 230 may be updated or customized by a user, for example via user interface 214 and user device 240. In some examples, users may submit or create new rules, which may also be stored to the rules engine 230. A back-end job or update process may create a sync between recommendations in the garbage collection DB 218 for updating the rules engine 230, or the rules engine 230 may be updated by a process such as the recommendation service 208 or the archival service 210. Likewise, metadata identified in the GC DB 218 may be updated based on the rules engine 230. For example, there may be a column indicating an action status for each metadata item in the GC DB 218, so that elements may be marked for tagging, archiving, deletion, etc. based on the rules in the rules engine 230. The rules of the rules engine 230 may be stored to a knowledge base repository or database 232.

The archival service 210 may automatically implement the rules defined in the rules engine 230. For example, the archival service 210 may automatically archive some metadata, and tag other metadata for user review, based on the rules engine 230, or based on the status column in the GC DB 218 set based on the rules engine 230. Once a user has reviewed tagged metadata and selected the elements to archive, the archival service 210 may also archive those elements. Archiving metadata may include removing that data from metadata DB 234, and storing it to garbage collection DB 218, cloud storage 228, or to another location. The archived metadata may be compressed or uncompressed, and may be stored to lower-cost or slower access nonvolatile memory devices than those that store active, non-archived metadata.

The dependency service 212 may scan and highlight a metadata dependency tree of related metadata elements, and populate the same in the graph DB 220. The graph DB 220 may in turn feed into the UI 214, allowing a user to better visualize how various metadata is related before making any customizations to archival rules or selecting or approving metadata to archive. For example, a user may be able to select data that is recommended or tagged for archiving, and be shown a full graph of all other metadata to which the tagged metadata relates. A user may then select to archive all or certain elements of the related metadata. The user may also use the visualization to make sure any dependencies by elements that aren't being archived are addressed, to avoid errors.

Scheduler service 216 may control the timing at which other services execute their operations. In some embodiments, scheduler 216 may be implemented as a Cron job, where cron may be a command-line utility that can act as a job scheduler on various operating systems. The scheduler 216 may control when monitoring service 206 reviews metadata usage and generates report 226, when archival service 210 executes rules-engine rules on metadata DB 234, or when dependency service 212 scans metadata DB 234 and updates graph DB 220 based on the metadata dependencies. In some examples, scheduler 216 may also control when recommendation service 208 reviews reports 226 to generate metrics and recommendations, when rules engine 230 is updated, or when other operations of resource optimizer 204 are performed.

User interface 214 may be a collection of features and operations for interaction with a user, for example via user device 240, to which resource optimizer 204 may be connected via the internet or other network connection. Accordingly, UI 214 may include a graphical user interface (GUI) application or platform with which the user may directly interact, as well elements such as a notification service 222 and a rollback service 224. UI 214 may receive or retrieve data from garbage collection DB 218, graph DB 220, knowledge base 232, cloud storage 228, or other elements. UI 214 may provide a user with information such as metadata usage reports 226, data metrics or recommendations from recommendation service 208 (e.g., via garbage collection DB 218), or metadata visualization graphs or charts from dependency service 212 (e.g., via graph DB 220). The UI 214 may show metadata that has been tagged for archival according to rules engine 230 rules, and may choose to archive or not archive the tagged metadata. The user may choose to archive metadata based on recommendations from recommendation service 208, which may not be based on rules engine 230 rules. A user may also be able to create or customize rules for the rules engine 230 via UI 214. UI 214 may also provide reports or lists of metadata that has been archived, and the rule or cause for the archiving the metadata.

UI 214 may include a notification service 222 that is configured to send or provide notifications to a user. Notifications may be provided via email, text messages, or in-app notifications through the UI. Notification service 222 may alert a user to pending recommendations, tagged data, new or proposed archiving rules, or other processes on which a user may act. The notification service 222 may also provide notifications or reports about archived data, such as what metadata was archived and the rule or cause of the archiving.

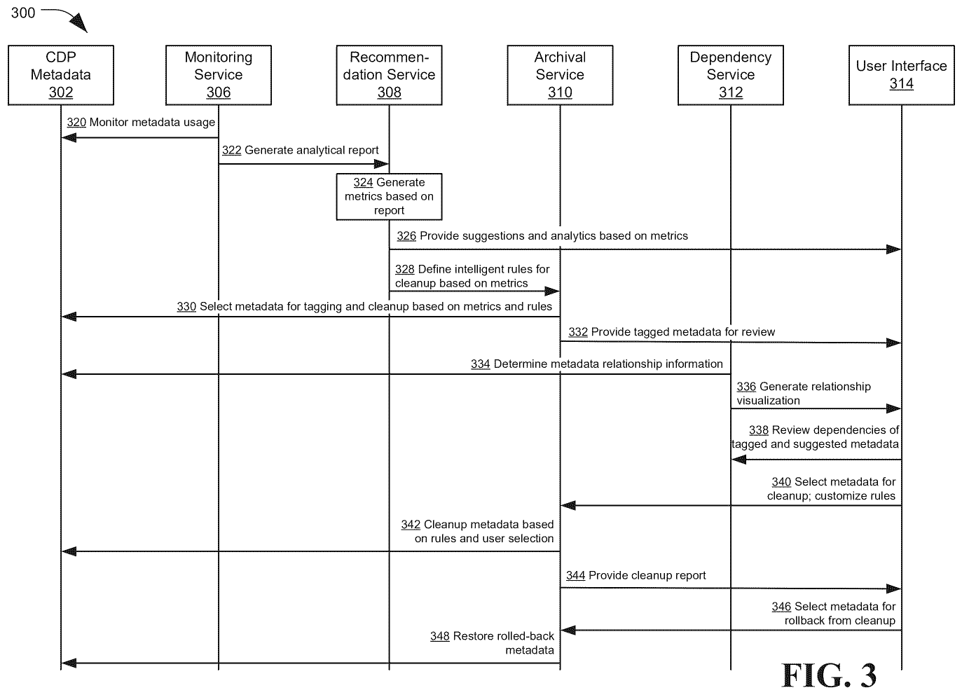

Rollback service 224 may provide a mechanism or interface via which a user may review archived metadata, and select elements to restore to the metadata DB 234. In this way, a user may “undo” or roll back archiving operations, and do not risk losing valuable metadata if a rules engine 230 rule captures an unexpected element. FIG. 3 depicts an example process for a resource optimizer for a customer data platform.

FIG. 3 is a flow diagram of an example system 300 for implementing a resource optimizer for a customer data platform, in accordance with certain embodiments of the present disclosure. In particular, system 300 may include a customer data platform (CDP) metadata store 302, a monitoring service 306, a recommendation service 308, an archival service 310, a dependency service 312, and a user interface 314. The components of system 300 may substantially correspond to the components of system 200 of FIG. 2.

At 320, the monitoring service 306 may monitor metadata usage of the CDP metadata 302. Based on the metadata usage, the monitoring service 306 may generate an analytical usage report, at 322, which may be provided to a recommendation service 308.

At 324, the recommendation service 308 may generate metrics and suggestions based on the report. The metrics and recommendations may highlight metadata that is infrequently used or has not been used for a period of time, that was created by or associated with a user without access rights, or is otherwise noteworthy. At 326, the recommendation service 308 may provide suggestions and analytics based on the generated metrics, for example via a user interface 314. The user interface 314 may receive the analytics and suggestions directly from recommendation service 308, or they may be obtained from an intermediary element, such as a garbage collection database.

At 328, the recommendation service 308 may provide or define intelligent rules for metadata cleanup based on the generated metrics, which rules may be received at or applied by archival service 310, in the form of a rules engine. The rules engine may also include default or user-defined rules. The archival service 310 may utilize the intelligent rules from the rules engine to select metadata from CDP metadata 302 for tagging and cleanup, based on the specific metrics for the metadata, at 330. At 332, the archival service 310 may provide tagged metadata for user review, via user interface 314.

Dependency service 312 may determine metadata relationship information from the CDP metadata 302, at 334. Metadata relationship information may include identifying what metadata elements are dependent or related to each other, and how. At 336, the dependency service 312 may generation a metadata relationship visualization, such as a graph or chart, and display it via UI 314.

At 336, a user may utilize UI 314 to review the tagged and suggested metadata, including reviewing their dependencies via a relationship visualization. At 340, a user may then select metadata for cleanup, and may customize or add rules engine rules, which selections and rules may be provided to or applied by archival service 310.

Archival service 310 may cleanup metadata at CDP metadata 302 based on the rules and user selection from 340, at 342. At 344, the archival service 310 may generate or provide a cleanup report of the archived metadata, for example via a notification service of UI 314.

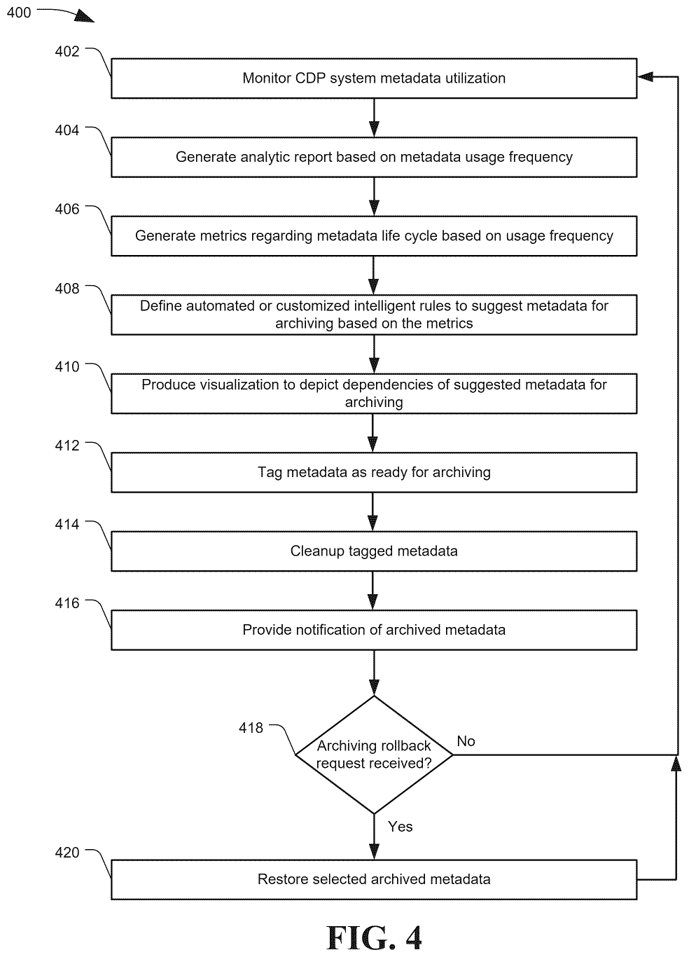

User interface 314 may enable a user to select archived metadata for rollback from cleanup, which selection may be provided to archival service 310, at 345. Based on the selected metadata, the archival service 310 may restore the selected data to CDP metadata 302, at 348. An example method of implementing a resource optimizer for a customer data platform is described in regard to FIG. 4.

FIG. 4 is a flowchart 400 of a method of implementing a resource optimizer for a customer data platform, in accordance with certain embodiments of the present disclosure. In particular, the method may depict an example method to evaluate the usage of CDP metadata, and apply a rule-based approach to remove or archive irrelevant or outdated metadata resources that may slow a CDPs performance, consume storage resources, and hinder a clean and efficient user experience. The method of flowchart 400 may be executed by components of a resource optimizer service, such as resource optimizer 104 of FIG. 1 or resource optimizer 204 of FIG. 2.

The method may include monitoring the usage of metadata elements of a CDP, such as tables, jobs, segments, campaigns, and other elements, at 402. The method may include generating an analytic report based on the metadata usage information, at 404. For example, the report may list, for various metadata elements, a last time it was accessed, an amount of time since it was updated, or other information. The report may include all metadata elements in a customer's CDP, all elements that have not been accessed or updated in a threshold period of time, or some other selected subset of elements.

At 406, the method may include generating metrics regarding metadata element life cycles based on the usage frequency. For example, the metrics may highlight jobs that have not been run in a last 90 days, or campaigns that have not been updated in a last 60 days, etc. In some embodiments, the metrics may be provided to a user for review, or suggestions or insights regarding metadata usage may be generated from the metrics and provided to a user.

The method may include defining automated or customized intelligent rules regarding metadata archiving based on the metrics, at 408. The rules may be for automatically archiving metadata, or for tagging metadata for user review prior to archiving. Some rules may be generated automatically, and may be customized or modified by a user. For example, the automatic rule may suggest archiving all jobs and segments that have not been used in 60 days, while a user may customize the rule to tag all jobs not run for 60 days, and to archive all segments not used for 90 days. Users may also submit new rules regarding tagging or archiving of data.

At 410, the method may include producing visualizations to depict dependencies of metadata elements, such as metadata that has been suggested or tagged for archiving. For example, a resource optimizer may review the metadata elements of the CDP to determine which elements interact with each other (e.g., which tables depend on which ingested data, and which jobs or segments depend on which tables, etc.). These dependencies or connections may be visually depicted in a tree or graph, such as a DAG, via which a user may more easily determine how the system elements work together.

The method may include selecting metadata to archive or tag for potential archiving, at 412. For example, the defined rules may specify that metadata meeting certain criteria are to be archived automatically, while other metadata should be tagged and presented to a user. The user may then confirm archiving for the tagged metadata, or may choose not to archive selected or all tagged elements. At 414, the method may include performing a cleanup of the tagged or selected metadata, such as by archiving it, or in some examples, deleting it entirely. Cleanup may include removing the selected metadata elements from a first memory store of the CDP, and archiving it in a second memory store. Archived data may not show up in normal CDP interfaces, may not undergo normal processing, and may not take up valuable high-speed storage resources. At 416, the method may include providing notification of the archived metadata to a user, which may identify which elements were archived, and the rule that caused them to be archived (e.g., not accessed for 90 days).

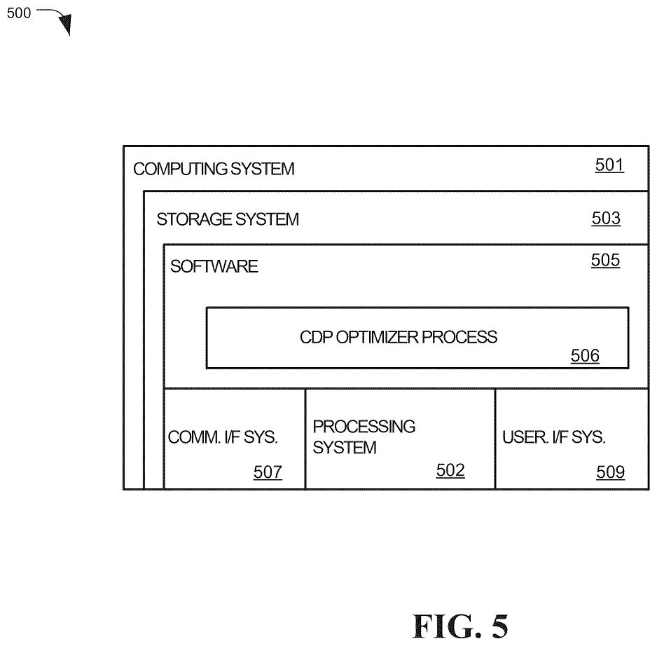

The resource optimizer may provide a user with the option to roll back archival operations. Accordingly, at 418, the method may include determining whether an archiving rollback request has been received. The rollback request may identify an archiving operation to rollback (e.g., all data archived on June 15), or may specify selected metadata elements to restore. If a rollback request was received, the method may include restoring the selected archived metadata to a primary metadata store of the CDP, at 420. Once the metadata has been restored, or if no rollback request was received, the method may return to monitoring the CDP system metadata utilization, at 402. A computing system configured to perform the operations and methods described herein is provided in regard to FIG. 5.

FIG. 5 illustrates an apparatus 500 including a computing system 501 that is representative of any system or collection of systems in which the various processes, systems, programs, services, and scenarios disclosed herein may be implemented. For example, computing system 501 may be an example of customer data platform (CDP) 102 or 202, resource optimizer 104 or 204, user device 240, or any constituent components as shown and described in FIGS. 1 and 2. Examples of computing system 501 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 501 may be implemented as a single apparatus, system, or device or may be implemented in a distributed manner as multiple apparatuses, systems, or devices. Computing system 501 may include, but is not limited to, processing system 502, storage system 503, software 505, communication interface system 507, and user interface system 509. Processing system 502 may be operatively coupled with storage system 503, communication interface system 507, and user interface system 509.

Processing system 502 may load and execute software 505 from storage system 503. Software 505 may include and implement CDP optimizer process 506, which may be representative of any of the operations for monitoring metadata usage at a CDP, generating usage metrics, generating and applying rules for tagging and archiving metadata, producing metadata dependency visualizations, providing notifications, and rolling back archiving operations at a resource optimizer, as discussed with respect to the preceding figures. When executed by processing system 502, software 505 may direct processing system 502 to operate as described herein for at least the various processes, operational scenarios, and sequences discussed in the foregoing implementations. Computing system 501 may optionally include additional devices, features, or functionality not discussed for purposes of brevity.

In some embodiments, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 may include general purpose central processing units, graphical processing units, application specific processors, and logic devices, as well as any other type of processing device, combinations, or variations thereof.

Storage system 503 may comprise any memory device or computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (including CDP optimizer process 506 among other functions) may be implemented in program instructions that may, when executed by processing system 502, direct processing system 502 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system customized to implement a bundled binding audit process as described herein. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

1. A resource optimizer system, comprising:
one or more processors; and
a memory having stored thereon instructions that, upon execution by the one or more processors, cause the one or more processors to implement a customer data platform (CDP) resource optimization process to remove obsolete metadata, the CDP resource optimization process including:
monitor metadata usage within a CDP, the metadata usage corresponding to accesses of the metadata;
generate metrics for a metadata element based on the metadata usage;
define a rule set for selecting the obsolete metadata for removal based on the metrics; and
apply the rule set to remove the obsolete metadata.

2. The resource optimizer system of claim 1, wherein removing the obsolete metadata includes archiving the obsolete metadata.

3. The resource optimizer system of claim 2, further comprising instructions that, upon execution, cause the one or more processors to:
generate a rule for the rule set based on the metrics;
receive a user customization to the rule to produce a customized rule; and
apply the rule set, including the customized rule, to remove the obsolete metadata.

4. The resource optimizer system of claim 3, wherein applying the rule set includes:
tag selected metadata as ready for removal;
receive a user input to mark chosen metadata from the selected metadata for removal; and
remove only the chosen metadata from the selected metadata.

5. The resource optimizer system of claim 4, wherein applying the rule set further includes:
tag first metadata for user-approved removal; and
automatically remove second metadata without user approval.

6. The resource optimizer system of claim 5, further comprising instructions that, upon execution, cause the one or more processors to:
determine dependencies between CDP metadata within the CDP; and
generate a visualization depicting the dependencies on a user interface (UI).

7. The resource optimizer system of claim 6, further comprising instructions that, upon execution, cause the one or more processors to:
provide a rollback option enabling a user to restore archived metadata;
receive a selection of rollback metadata via the rollback option; and
restore the rollback metadata to the CDP.

8. The resource optimizer system of claim 7, further comprising instructions that, upon execution, cause the one or more processors to:
generate a notification identifying:
the obsolete metadata removed by the CDP resource optimization process;
a corresponding rule based on which each obsolete metadata element was removed; and
provide the notification to the user.

9. The resource optimizer system of claim 8, further comprising instructions that, upon execution, cause the one or more processors to:
generate suggestions of metadata to consider for removal based on the metrics, the suggestions not based on the rule set; and
provide the suggestions to the user.

10. The resource optimizer system of claim 9, wherein the metrics identify an amount of time since the metadata element has been utilized.

11. A method comprising:
operating a resource optimizer system to implement a customer data platform (CDP) resource optimization process to remove obsolete metadata, the CDP resource optimization process including:
monitoring metadata usage within a CDP, the metadata usage corresponding to accesses of the metadata;
generating metrics for a metadata element based on the metadata usage;
defining a rule set for selecting the obsolete metadata for removal based on the metrics; and
applying the rule set to remove the obsolete metadata.

12. The method of claim 11, wherein removing the obsolete metadata includes archiving the obsolete metadata.

13. The method of claim 11, further comprising:
generating a rule for the rule set based on the metrics;
receiving a user customization to the rule to produce a customized rule; and
applying the rule set, including the customized rule, to remove the obsolete metadata.

14. The method of claim 11, further comprising:
applying the rule set includes:
tagging selected metadata as ready for removal;
receiving a user input to mark chosen metadata from the selected metadata for removal; and
removing only the chosen metadata from the selected metadata.

15. The method of claim 14, further comprising:
applying the rule set further includes:
tagging first metadata for user-approved removal; and
automatically removing second metadata without user approval.

16. The method of claim 11, further comprising:
determining dependencies between CDP metadata within the CDP; and
generating a visualization depicting the dependencies on a user interface (UI).

17. The method of claim 11, further comprising:
providing a rollback option enabling a user to restore archived metadata;
receiving a selection of rollback metadata via the rollback option; and
restoring the rollback metadata to the CDP.

18. The method of claim 11, further comprising:
generating a notification identifying:
the obsolete metadata removed by the CDP resource optimization process;
a corresponding rule based on which each obsolete metadata element was removed; and
providing the notification to a user.

19. The method of claim 11, further comprising:
generating suggestions of metadata to consider for removal based on the metrics, the suggestions not based on the rule set; and
providing the suggestions to a user.

20. The method of claim 11, wherein the metrics identify an amount of time since the metadata element has been utilized.
